(19) United States
(12) Patent Application Publication
(10) Pub. No.: US 2024/0086060 A1
(43) Pub. Date: Mar. 14, 2024

(54) GRAPHICAL USER INTERFACE FOR NUANCED EXPLICIT FEEDBACK AND SIMULTANEOUS NAVIGATION THROUGH MEDIA

(71) Applicants: Kevin Thomas Gillespie, Stevenson Ranch, CA (US); Daniel Tsan, Castaic, CA (US)

(72) Inventors: Kevin Thomas Gillespie, Stevenson Ranch, CA (US); Daniel Tsan, Castaic, CA (US)

(21) Appl. No.: 18/367,473

(22) Filed: Sep. 13, 2023

Related U.S. Application Data
(60) Provisional application No. 63/406,226, filed on Sep. 13, 2022.

(51) Int. Cl. G06F 3/0488; G06F 3/04817; G06F 3/0484

(52) U.S. Cl. CPC G06F 3/0488; G06F 3/04817; G06F 3/0484

(57) ABSTRACT

Some embodiments provide a novel graphical user interface (GUI) for simultaneous collecting of nuanced explicit feedback about a current piece of computer readable media from a user and triggering of a transition to a following piece of computer readable media, requiring only a single gesture from a given user. The GUI features a visual element that approximately indicates to a user what numerical explicit feedback score will be used once the gesture interaction is finalized. In some embodiments, the visual element is a colored portion of the GUI where the proportion of the GUI covered corresponds closely with the numerical explicit feedback score. In other embodiments, the visual element consists of a sequence of icons. The numerical explicit feedback, contextualized by an implicit feedback weight and additional data, can be used in the construction of content recommendation profiles for the generation of candidate pieces of computer readable media.

### CROSS-REFERENCE TO RELATED APPLICATIONS

This application claims the benefit of provisional patent application Ser. No. 63/406,226, filed 2022 Sep 13 by the present inventors, which is incorporated by reference in its entirety.

### FEDERALLY SPONSORED RESEARCH

nonapplicable

### SEQUENCE LISTING OR PROGRAM

nonapplicable

### TECHNICAL FIELD

The present invention relates to recommendation systems for computer readable media, and more particularly to the graphical user interfaces used to collect explicit feedback.

### BACKGROUND ART

Many media-displaying services use recommendation algorithms as an efficient means of helping a user navigate an exorbitant amount of media content in a personalized manner. To have the data required to perform such a task, various forms of feedback must be used. Feedback data that is sourced directly from a user input is called explicit feedback. Recommendation systems may also rely on implicit feedback, including signals such as time spent. Explicit and implicit feedback are combined with mathematical models and vector embeddings to create preference profiles, which are then used to generate, score, and rerank media candidates for media content recommendations.

Current explicit feedback methods for media content often consist of limited, binary information, such as the like button. Various users may have differing thresholds for what constitutes providing a certain explicit feedback response. Additionally, implicit feedback can signify two very different things at once; for example, a user could enjoy or dislike the media content in the event of sharing it or watching for a long time.

The lack of complete and uniform information conveyed by current explicit feedback and the contradictory nature of the use of implicit feedback culminates in an overall decreased ability to make accurate judgements as to how much a user enjoys a piece of media content, occasionally resulting in unwanted media content recommendations. By extension, this also impacts what a user's assumed preferences are, what future content should be recommended to them, and the quality of data collected on users, posts, and creators.

Another explicit feedback method that has been used is a star rating, where a user selects an amount of stars to classify how much they like a piece of media content. While this contains more nuance than a like button, it is typically not continuous and also requires the user to touch a specific defined area separate from the operation of other aspects of the program. The usage of the star rating component also corresponds directly with the making of a decision, with less time for thought contained in the operation of the feedback component itself.

One other traditional graphical user element is known as a slider, which typically takes the form of an object that a user directly drags along a predetermined path in order to respond to a prompt. This graphical user element is often used for polls and questionnaires rather than feedback on computer readable media in mainstream applications. Similar to a star rating, such an element contains more nuance that can even be continuous, but it also exists in isolation and requires the user to touch a smaller specific area that can make an interface prone to user misgestures.

Additionally, an effective means of displaying media content is a “scroll feed” where a user can use a gesture motion on the device to move to the following piece of media content, known colloquially as “swiping” or “scrolling.” The user's evaluation of the content which can be used for recommendation purposes, both explicit and implicit, is either done while viewing the relevant media or collected indirectly.

One other existing media rating system is known colloquially as “swiping left” and “swiping right,” most often in dating applications. In this case, the gathering of explicit feedback coincides with navigating through media content, increasing the ease with which a user can provide explicit feedback. However, the explicit feedback is still binary with a multitude of separate gestures, inconsistent usage thresholds that differ between users, and little room for numerical nuance.

### SUMMARY OF THE EMBODIMENTS

We have devised a graphical user interface (GUI) that allows a user to provide nuanced, explicit feedback contained within the motion used to navigate between pieces of computer readable media.

Some embodiments of the GUI consist of computer readable media accompanied by a gesture handler which accepts user input. When a user begins to interact with the gesture handler, a visual element on the screen begins to transform in conjunction with the magnitude of the user's gesture interaction. In some embodiments, this gesture handler can accept gesture input from anywhere within the GUI, being entirely separate from the visual element it controls. Thus, the operation of these embodiments integrates with the gesture used to swipe or scroll through computer readable media. Simultaneously, an explicit feedback score is continuously calculated as a function of the user's input to the gesture handler.

Once a user releases their gesture without canceling, the explicit feedback score is finalized for the piece of media being displayed, and a transition is triggered to move to the next piece of computer readable media. The process then repeats as long as the user continues to interact with various aspects of the invention. The explicit feedback score, in combination with contextualizing data and an implicit feedback weight derived from additional factors, can then be stored or transmitted to a remote internet server. This data can then be used to improve recommendation profiles and post classifications to assist in the generation of media recommendations. The end result of some embodiments is navigation to a following piece of computer readable media while simultaneously providing explicit feedback to the current piece of computer readable media.

In one such embodiment, the visual element is rendered on top of the computer readable and consists of a tinted component that moves from the bottom to the top of the screen. Thus, the position of this visual element approximately indicates to the user what explicit feedback score the device has presently calculated, allowing the user to understand what rating they will have given the piece of media content when they complete a gesture without canceling. The user can start and end their gesture anywhere on the GUI display, not limited to the location of the visual element nor to a linear driving function for the transformation of the visual element. Another embodiment includes a visual element that does not move across the screen, but instead dynamically changes from one shape to another shape, such as smoothly transitioning from a “thumbs down” to a “thumbs up” to a heart shape.

### BRIEF DESCRIPTION OF THE DRAWINGS

The novel features of the invention are set forth in the appended claims. However, for the purposes of explanation, various embodiments of the invention are presented in the following figures, alongside a flow chart of the program to be executed on a nontransitory computer readable medium.

FIG. 1A conceptually illustrates one possible user input to a gesture handler within an embodiment of a graphical user interface for providing explicit feedback and triggering transitions to following pieces of media content, as well as a form of a visual element which approximately indicates the numerical explicit feedback score.

FIG. 1B conceptually illustrates another possible user input to a gesture handler within an embodiment of a graphical user interface wherein there exists an upper bound on the numerical explicit feedback score corresponding to an upper limit on the transformation of a visual element.

FIG. 1C conceptually illustrates another possible user input to a gesture handler within an embodiment of a graphical user interface wherein a form of a visual element which approximately indicates the numerical explicit feedback score emerges in response to the start of the user input.

FIG. 2 conceptually illustrates a process of some embodiments for a program stored in a nontransitory computer readable medium to determine a numerical explicit feedback score for use in a recommendation system and simultaneously trigger a transition to a following piece of media content.

FIG. 3 conceptually illustrates an embodiment of the GUI's transition from one piece of computer readable media to a following piece of computer readable media in response to explicit feedback being received from a user's input to an overlaid gesture handler.

FIG. 4 conceptually illustrates one embodiment of a driving function that relates the transformation of a visual element and the magnitude of a user's gesture, in some embodiments consisting of the displacement of the gesture.

FIG. 5A conceptually illustrates one embodiment of a function that relates the numerical explicit feedback score with the magnitude of a detected gesture.

FIG. 5B conceptually illustrates one embodiment of a function that relates the transformation of a visual element with the numerical explicit feedback score.

FIG. 6 conceptually illustrates another form of a visual element for some embodiments that visually morphs in a manner that is driven by the gesture input which also approximately indicates the current numerical explicit feedback score to a user.

FIG. 7 conceptually illustrates a data structure as produced by a user's interaction with some embodiments, including identifying information, the numerical explicit feedback score, and an implicit feedback weight.

FIG. 8 illustrates components in a touch screen computing device architecture necessary for executing a computer program to detect gestures, process inputs, and transmit results to remote servers during the operation of some embodiments.

### REFERENCE NUMERALS

100—The graphical user interface (GUI) containing a gesture handler of a handheld mobile device for some embodiments
110, 114, 112, 120, 122, 124, 130, 132, 134, 305, 320—Various transforms of the upper edge of a visual element that, in some embodiments, extends to the full screen below
111, 113, 115, 121, 123, 125, 126, 131, 133, 135, 310, 315—Various positions of a gesture interaction performed by a user and detected by a gesture handler on a display
200, 205, 210, 215, 220, 225, 230, 235, 240, 245, 250, 255—Elements of a flow chart describing steps carried out by a computer program in some embodiments for the making and using of the invention
300—Current piece of computer readable media
325—Transition to a following piece of computer readable media
330—Following piece of computer readable media
400—Axis of a gesture interaction detected by a gesture handler on a display
405—Axis of a transformation of the visual element in this embodiment
410, 420—Possible forms of a function relationship between the motion of a visual element and the magnitude of a gesture interaction provided by a user for some embodiments
415—The upper limit of a visual element's transformation with respect to a user's gesture interaction in some embodiments
505—Axis of a numerical explicit feedback score
510, 520—Possible forms of a function relationship between a numerical explicit feedback score and a gesture interaction provided by a user for some embodiments
515—Maximum numerical explicit feedback score
530—Maximum transformation of the visual element
535—Possible function relationship between the numerical explicit feedback score and the transformation of a visual element in some embodiments
540—Origin of the function relationship 535
605, 610, 615, 620, 625, 630—For one embodiment, various states of a visual element which continuously indicates to a user an approximate explicit feedback score being calculated until said score is finalized
700, 730, 735—Collections of data in an appropriate data structure
705, 710, 715, 720, 725—Accompanying data fields in a data structure for the contextualization of an explicit feedback score upon transmission of feedback to a remote internet server
800—Instructions for a computing device defined by a computer program
805—Nontransitory memory of a computing device
810—Processing units of a computing device
815—Peripherals Interface of a computing device
820—I/O subsystem of a computing device
825—Wireless communication subsystem of a computing device

### DETAILED DESCRIPTION OF SPECIFIC EMBODIMENTS

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

I. Operation of the Invention

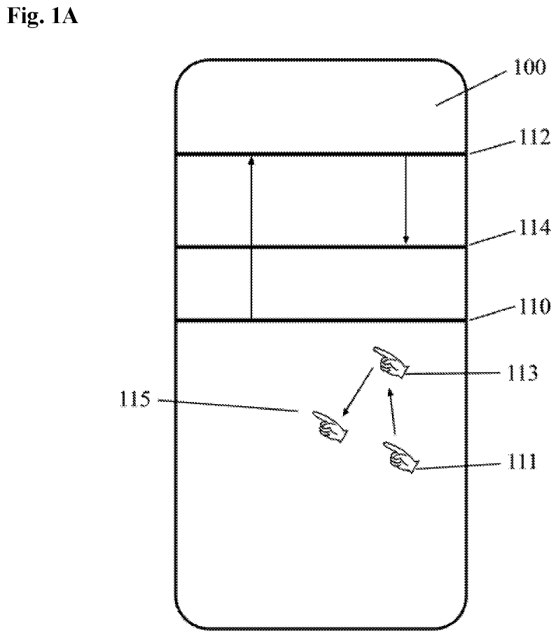

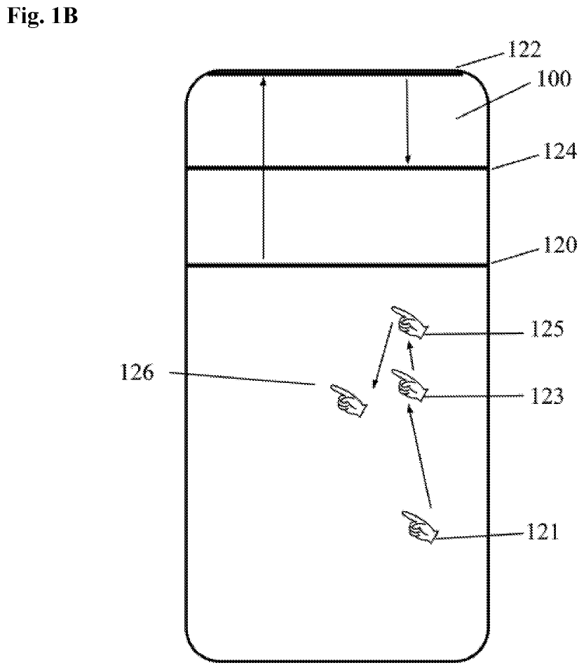

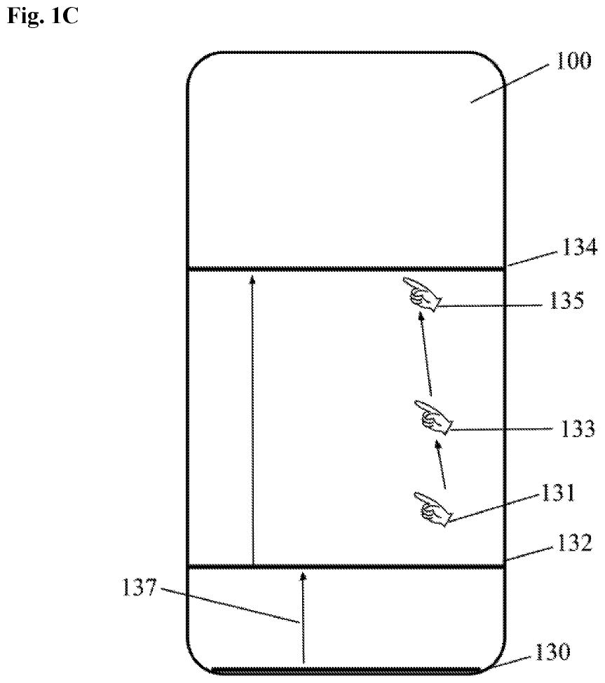

FIG. 1 conceptually illustrates how a user might interact with the invention in order to provide a numerical explicit feedback score in some embodiments. FIG. 1A shows a user providing a gesture interaction 111 via a gesture handler on a GUI 100. In this embodiment, the region for accepting a gesture interaction is the entire GUI 100, and the gesture interaction 111 is a pan gesture that starts and ends at two different points on the GUI 100 and can take any amount of time. A visual element 110 in this embodiment is a rectangular region of the screen extending below the line. After the input changes to the gesture 113, said visual element 112 correspondingly moves to a new higher position. Similarly, if said user's gesture interaction further updates to gesture 115, said visual element 114 moves down.

When said user releases the gesture interaction 111, 113, or 115, without canceling, the user's numerical explicit feedback score for the computer readable media is computed by a processing unit 810, in some embodiments, by a function 510 relating the magnitude of the gesture interaction 400, which is the distance traveled by the gesture in this embodiment, to the score itself 505. In this embodiment, this means that the visual element 112 being higher within the GUI 100 corresponds with a higher numerical explicit feedback score 715. Simultaneously, a transition 325 to a following piece of computer readable media is triggered.

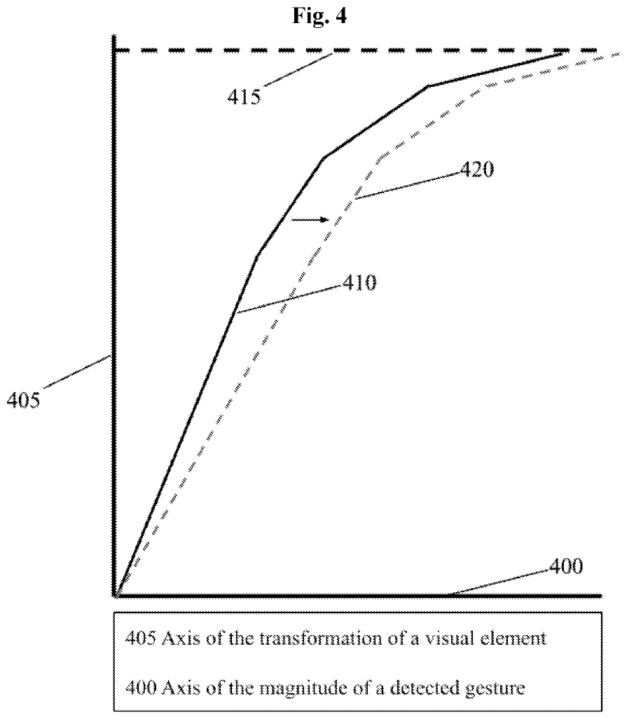

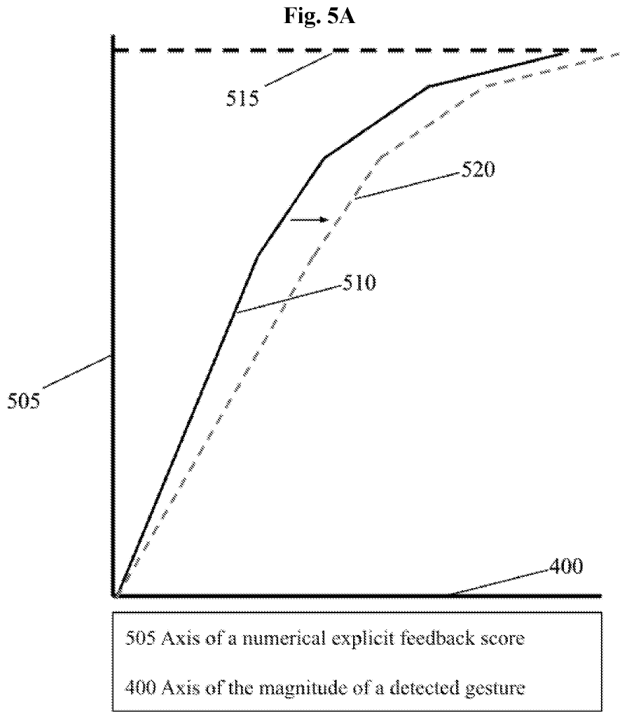

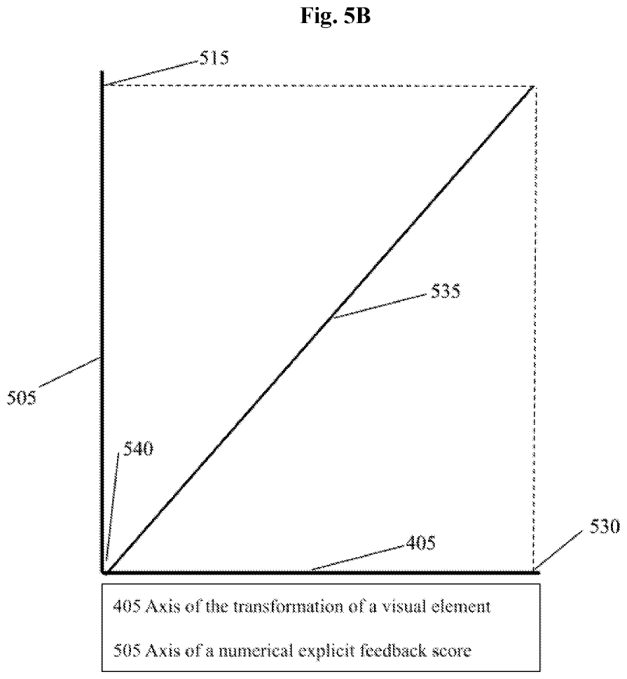

FIG. 1B illustrates another gesture interaction 121 which moves to become gesture 123. Correspondingly, the visual element 120 becomes the visual element 122, which is at the top of the GUI 100. When the gesture 123 moves further to become gesture 125, the visual element 122 does not move any further due to bounding effects within this embodiment, determined by the height of the GUI 127. Correspondingly, as is demonstrated in FIGS. 4 and 5, there is a maximum amount of transformation for the visual element which corresponds closely with the numerical explicit feedback score 715 being calculated, allowing the user to approximately calculate the numerical explicit feedback score 715 they are selecting prior to releasing the slider and triggering the transition.

In FIG. 1C, the visual element 130 starts near the bottom of the GUI 100. When the gesture 131 begins, the invention is activated. The visual element 130 transforms to become the element 132 as the gesture 131 moves to become gesture 133. Similarly, the visual element 132 transforms to become the element 134 as the gesture 133 moves to become gesture 135. As illustrated by the embodiments shown in FIG. 1, after activating the invention by starting a gesture interaction from any point on the GUI 100, the user can move this gesture to control a visual element which indicates an approximate explicit feedback score 715. One ordinarily skilled in the art would recognize that there are many other possible embodiments of such a gesture interaction and visual element in order to indicate such a continuous, explicit feedback score.

II. Process Flow Diagram

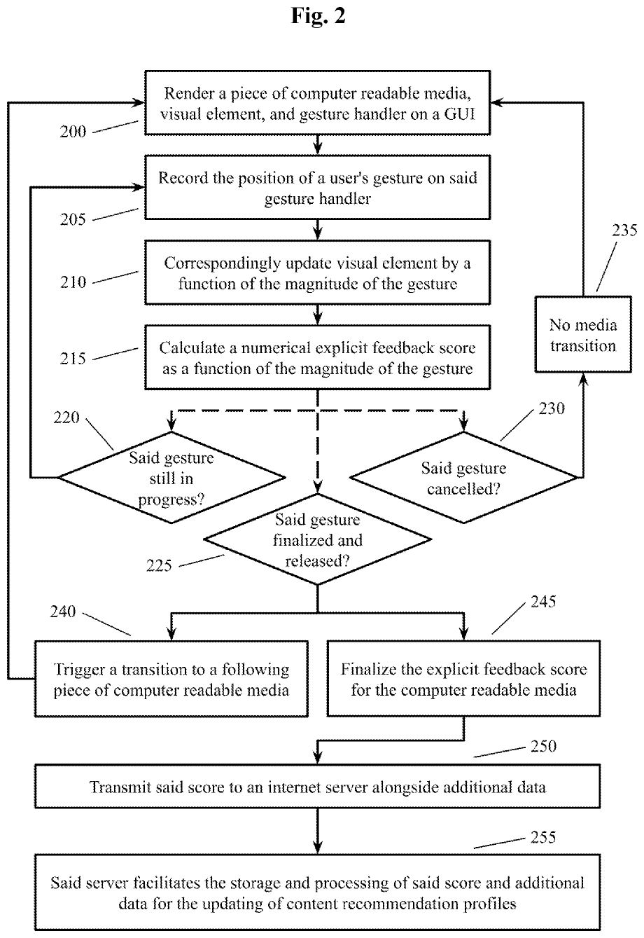

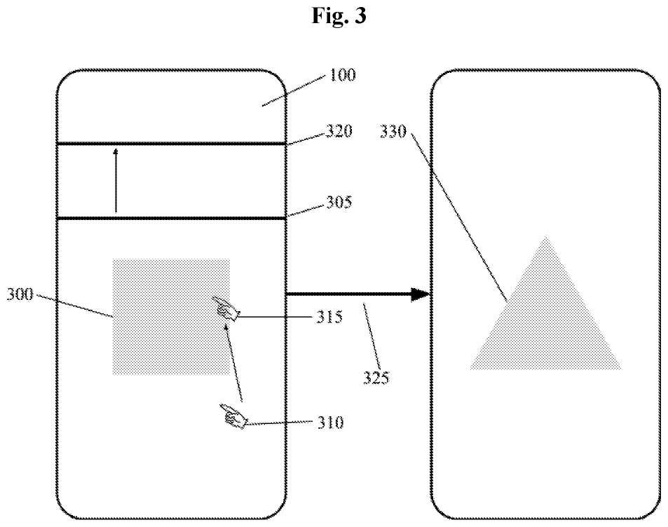

FIG. 2 outlines the implementation of various aspects of the invention for some embodiments to be performed by a nontransitory computer readable medium storing a computer program, while FIG. 3 serves as a visual example for such an embodiment. The process begins with rendering a piece of current computer readable media 300 within a GUI 100 which can also detect user gestures 200. When such a gesture 310 starts, the position of a user's gesture within said GUI is recorded 205. A visual element 305 is then updated according to a driving function of said user's gesture 310, possible forms of which are shown in FIG. 4 and FIG. 6. At this point, the processing unit calculates a numerical explicit feedback score value as a function of the magnitude of said user's gesture 215, a possible form of which is shown by FIG. 5.

If the gesture 200 has not been finalized, steps 205, 210, and 215 are repeated in a loop. After step 215, if the gesture 200 has been canceled 230 after any number of loops, no transition to a following piece of computer readable media is triggered, and no numerical explicit feedback score is collected. The gesture interaction 310 could move to become the gesture 315, while the visual element 305 transforms into element 320. The user could continue to adjust their gesture interaction 310 for any length of time, correspondingly transforming the visual element 305 and recalculating the numerical explicit feedback score 715. Once the gesture 310 takes any of a plurality of possible motion paths within the GUI 100 and is finalized by being released 225, two main steps are triggered simultaneously.

A transition 325 to a following piece of computer readable media 330 from a current piece of computer readable media 300 is triggered 240. One reasonably skilled in the art would know that a transition between pieces of computer readable media can take on a plurality of forms, including sliding off the screen, fading away, or immediately switching. Simultaneous to this transition upon finalizing and releasing the gesture interaction 225, an explicit feedback score is finalized 245 by the user for the computer readable media 300 based on the final state of the gesture 315 upon step 225.

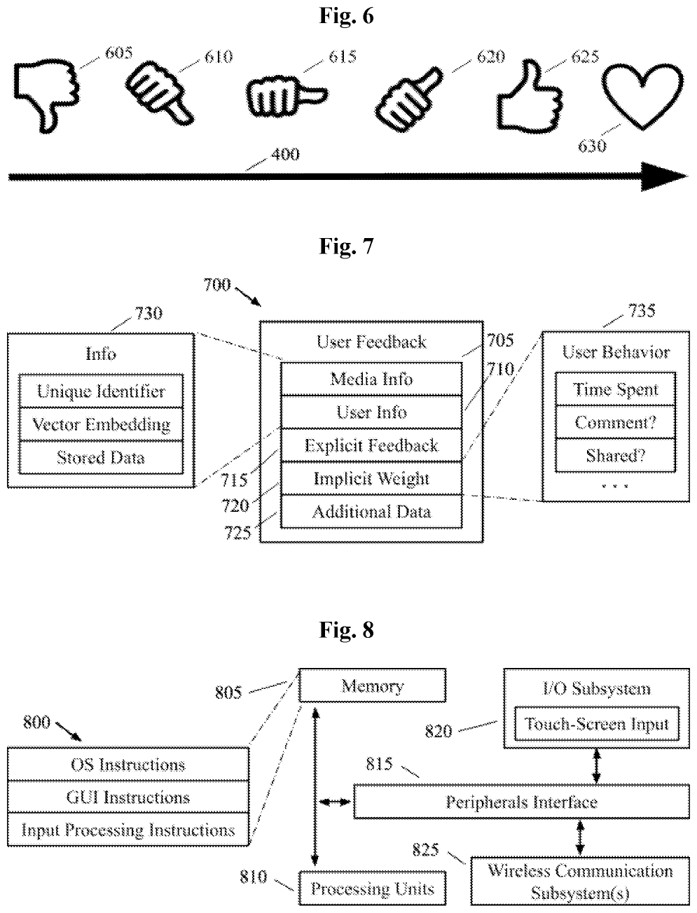

An implicit feedback weight 720 can be determined at this stage, in some embodiments including user behavior 735 such as time spent or whether the user interacted with the computer readable media in other ways such as commenting and sharing, conceptually illustrated in FIG. 7. Both scores take the form of a floating or fixed point value interpretable by a computer program in some embodiments.

Next, in some embodiments, the explicit feedback score, implicit feedback weight, and any accompanying contextualizing data concerning the user or the current piece of computer readable media can be transmitted to a remote internet server 250. The server facilitates the storage and processing of the scores and weights for the purpose of updating content recommendation profiles relevant to generating media recommendations for users 255.

III. Driving Functions Between Gestures, Scores, and Visual Transformations FIG. 4 illustrates an embodiment of the function relating the transformation of the visual element 405 to the magnitude of a detected gesture 400. In some embodiments, the transformation of the visual element 405 consists of a translation upward, and the magnitude of the detected gesture 400 is based on the displacement of a gesture interaction along the vertical direction up the GUI 100. There is an upper limit 415 to the motion of the visual element in this embodiment, corresponding with an upper limit to the explicit numerical feedback score 715 a user can input.

Function 410 and function 420, shaped similarly to one half of a parabola, are two possible forms for a function to define the values along axis 405 from zero to the upper limit 415. The closer the transformation of the visual element gets to its upper limit, these particular functions begin to require a greater amount of change in the gesture magnitude 400 in order to transform the visual element and corresponding explicit feedback score 715 the same amount.

FIG. 5A illustrates how the calculated numerical explicit feedback score 715 along an axis 505 is defined by a function such as function 510 or function 520 which takes the magnitude of the gesture 400 as input. Corresponding to FIG. 4, there is an upper limit 515 to the numerical explicit feedback score. In some embodiments, the upper limit is one, such that the resulting score can be any number of the continuous interval spanning zero to one, inclusive or exclusive. However, it would be clear to anyone skilled in the art that these upper and lower limits could be equivalently set to any other values.

In this embodiment, the similarity in shape of function 510 to calculate the explicit feedback score 715 and function 410 to determine the transformation of the visual element 405, both with respect to the magnitude of the gesture 400, illustrates how a user may be able to approximately calculate the explicit feedback score 715 they plan to give to a piece of computer readable media throughout the operation of various aspects of the invention. Thus, the transformation of the visual element 405 occurs in such a way that the user can approximately determine how they are rating a piece of computer readable media prior to triggering the transition to the following piece of computer readable media.

FIG. 5B shows the corresponding function of the numerical explicit feedback score 505 but with respect to the transformation of the visual element 405, combining FIG. 4 and FIG. 5A for some embodiments. There is a maximum score value 515 and a maximum transformation of the visual element 530. From the lower limit of both the score and transformation 540, a function relationship 535 directly relates the selected explicit feedback score along the axis 505 with the transformation of the visual element 405 since both are driven by the same gesture interaction, 400. This functional relationship 535 is linear in this embodiment, though one reasonably skilled in the art would see that it can take a plurality of forms in other embodiments, such as being a non-binary discrete function or a quadratic curve.

FIG. 6 illustrates another embodiment where the visual element is made up of icons rather than an area within the GUI. These icons can similarly approximately indicate to a user the presently calculated numerical feedback score 715. As the magnitude of the detected gesture 400 changes, the icons can switch, rotate, move, or otherwise animate between each other according to a function. This particular embodiment involves a transition from a thumbs down 605 to a half thumbs down 610, middle thumb 615, half thumbs up 620, full thumbs up 625, and a heart 630 as the magnitude of the detected gesture 400 increases. Because these icons qualitatively indicate what explicit feedback score 715 is being calculated by the processor 810, they serve as a visual element for additional embodiments of the invention.

The visual element is used to signal to a user what the numerical explicit feedback score 715 is meant to represent. The icons of FIG. 6 signal to the user that explicit feedback regarding the user's overall opinion of the content is being collected. However, in various embodiments, different sequences of icons comprising the visual element can be used in order to prompt users for different modes of continuous feedback, such as for collecting numerical explicit feedback concerning emotional reaction to a piece of computer readable media.

IV. Data Structures and Computing Architecture

FIG. 7 conceptually illustrates a data structure 700 used for storing or transmitting feedback information to an internet server 250 for use in the updating of content recommendation profiles 255, which is facilitated by the wireless communication subsystems 825 of the computing device. In some embodiments, the user feedback data structure 700 includes media identifying information 705, user identifying information 710, the numerical explicit feedback score 715, an implicit weight 720, and any additional contextualizing data 725.

Both the media information 705 and user information 710 consist of items 730 such as a unique identifier, vector embeddings which represent the semantic meaning of the media or a user's preferences, and other stored data such as timestamps. The information in 730 for both media and users can be used in order to update classifications for computer readable media and recommendation profiles for users.

The user behavior data 735 which includes information such as the user's time spent on the computer readable media and whether the user commented or shared the media with others can be used to create an implicit feedback weight 720 which further contextualizes the numerical explicit feedback score 715 provided by the user's operation of various aspects of the invention.

In some embodiments such as shown in FIGS. 1 and 3, various aspects of the invention are operated on a handheld computing device GUI 100. FIG. 8 shows relevant components of the computing architecture of such a device. The instructions 800 for carrying out the entire process of operating the invention are kept in a computer program in nontransitory memory 805. A peripherals interface 815 facilitates communication between the memory 805, processing units 810, and subsystems such as I/O 820 for handling gesture interactions and wireless communication 825 for transmitting data to other computing devices.

The instructions 800 kept in memory 805, with input from the peripherals 815, allow the processing units 810 to execute every step described in FIG. 2, keeping track of an explicit feedback score 715 in the form of a floating or fixed point representation in memory 805 while the user is operating the invention. Additionally, the processing units 810 compute the corresponding visual transformations 210 and media transition 240 in response to user input 205 and explicit feedback score finalization 245.

In some embodiments, this I/O subsystem 820 consists of touchscreen input and a visual display for showing computer readable media. One reasonably skilled in the art would recognize that this input could consist of any gesture or GUI interaction that has a magnitude that can be adjusted.

Correspondingly, any gesture not involved in the operation of the invention can be used for other functionality such as pausing and skipping through computer readable media in the case of video or audio.

### CONCLUSION

The invention can be applied to the collection of explicit feedback for and navigation through any type of computer readable media, whether it be video, image, audio, or text. It can be applied to the collection and contextualization of relevant data to the construction of preferential profiles for the gathering of candidates for recommendation of computer readable media, although the explicit feedback can just as simply be used for any other purpose, whether it be transmitted to a remote internet server, kept local on the computing device, or transmitted to another device.

Various aspects of the invention for simultaneously collecting nuanced explicit feedback and navigating through computer readable media may have one or more of the following advantages over the current standards for collecting explicit user feedback and navigation through computer readable media. They simultaneously facilitate more nuance than traditional explicit feedback methods which can be used for the creation of accurate recommendation preference profiles, provide additional contextualization for traditionally employed implicit feedback methods such as time spent, and merge the act of providing said nuanced explicit feedback for the computer readable media with navigation to the following piece of computer readable media.

As a result, a user operating the invention can provide more detailed explicit feedback concerning their opinions of or response to computer readable media with fewer physical gesture motions than current alternatives. Even if the number of physical motions to both provide explicit feedback and navigate were the same, various embodiments of the invention provide an accompanying visual element which continuously indicates the current state of the explicit feedback being provided until a user decides to finalize their score and transition to the following piece of computer readable media. Thus, only a single type of gesture interaction that is linked to navigation and has a continuum of possible states is required as opposed to multiple types of gestures which in some form represent different commands and discrete feedback scores.

What is claimed is:

1. A nontransitory computer readable medium storing a computer program which when executed by at least one processor provides a graphical user interface (GUI) for controlling an application, said GUI comprising:
a. a piece of computer readable media;
b. a gesture handler, capable of detecting gestures being able to originate from a plurality of locations on said GUI;
c. a visual element that visibility transforms into a plurality of forms in conjunction with a user's gesture interaction with said gesture handler;
d. a numerical explicit feedback score with a plurality of possible magnitudes which each correspond to a form of said visual element such that said user can approximately determine said numerical value from said visual element; and
e. a transition to a following piece of computer readable media, after said user has interacted with said gesture handler to transform said visual element and provide said numerical explicit feedback score, upon said user's completion of the input to said gesture handler, whereby the collection of explicit feedback for said piece of computer readable media from a user is simultaneous with said user's decision to navigate to said following piece of computer readable media.

2. The nontransitory computer readable medium of claim 1, wherein said gesture handler is positioned so that it shares area within said GUI with said computer readable media.

3. The nontransitory computer readable medium of claim 1, wherein said visual element is a visual that moves across said GUI.

4. The nontransitory computer readable medium of claim 1, wherein said visual element is a sequence of visual icons with a plurality of possible transitions between the subelements of said sequence of visual icons.

5. The nontransitory computer readable medium of claim 1, wherein said visual element is visible prior to the initiation of said user's input to said gesture handler.

6. The nontransitory computer readable medium of claim 1, wherein said visual element moves according to a function of a displacement metric of said user's input to said gesture handler.

7. The nontransitory computer readable medium of claim 1, wherein said numerical explicit feedback score is computed as a function of said user's gesture interaction's magnitude.

8. The nontransitory computer readable medium of claim 1, wherein said numerical explicit feedback score can be transmitted to a remote internet server for use in improving a content recommendation profile for said user.

9. The nontransitory computer readable medium of claim 1, wherein said numerical explicit feedback score is weighted by implicit feedback, determined by a function of time spent on said piece of computer readable media.

10. The nontransitory computer readable medium of claim 1, wherein said transition and determination of said numerical explicit feedback score can be canceled by said user by ending input to said gesture handler in one of a plurality of locations on said GUI.

11. A tangible, nontransitory, computer readable medium in which is nontransitorily stored computer program code that, when executed by a computer processor, causes performance of a method for collecting feedback on a current piece of computer readable media in conjunction with transitioning to a following piece of computer readable media, said method comprising:
a. displaying said current piece of computer readable media on a GUI;
b. accepting a gesture interaction from a user within a region of said GUI;
c. calculating a numerical explicit feedback score as a function of said gesture interaction's magnitude;
d. finalizing said numerical explicit feedback score once said user ends said gesture interaction; and
e. triggering a transition from said current piece of computer readable media to said following piece of computer readable media once said user ends said gesture interaction, whereby said gesture interaction results in both said numerical explicit feedback score being finalized for said current piece of computer readable media and said transition occurring.

12. The medium of claim 11, further including rendering a visible element on said GUI with an appearance that changes with a driving function taking said gesture interaction's magnitude as input, whereby said appearance permits an approximate calculation of said numerical explicit feedback score by said user.

13. The medium of claim 11, further including transmitting said numerical explicit feedback score alongside contextualizing data to a remote internet server for use in content recommendation profiles.

14. The medium of claim 11, wherein said numerical explicit feedback score is accompanied in a data structure by an implicit feedback weight derived from a function including said user's time spent on said current piece of computer readable media as input.

15. The medium of claim 11, wherein said GUI is on a handheld mobile device.

16. The medium of claim 11, wherein said region for accepting said gesture interaction on said GUI comprises an area overlapping with the area of said current piece of computer readable media.

17. The medium of claim 11, wherein said numerical explicit feedback score is equal to any of a plurality of floating or fixed point numbers between zero and one.

18. The medium of claim 11, wherein said transition consists of an actuation of said current piece of computer readable media out of view of said GUI, whereby said following piece of computer readable becomes perceivable to said user.

19. The medium of claim 11, wherein said method is repeatable by treating said following piece of computer readable media as a new current piece of computer readable media and by queueing a new following piece of computer readable media.

20. The medium of claim 11, wherein said gesture interaction can result in other functionality if said functionality does not conflict with said method for collecting feedback on said current piece of computer readable media in conjunction with transitioning to said following piece of computer readable media.
